(19) United States
(12) Patent Application Publication
(10) Pub. No.: US 2025/0307688 A1
(43) Pub. Date: Oct. 2, 2025

(54) ACTION SEQUENCE GENERATION FOR REAL-TIME EVENTS USING A UNIFIED SCHEMA

(71) Applicant: Microsoft Technology Licensing, LLC, Redmond, WA (US)

(72) Inventors: Zichu Li, San Jose, CA (US); Lu Chen, Sunnyvale, CA (US); Shifu Wang, San Jose, CA (US); Lingjie Weng, Sunnyvale, CA (US)

(21) Appl. No.: 18/617,314

(22) Filed: Mar. 26, 2024

(51) Int. Cl. G06N 20/00

(52) U.S. Cl. CPC G06N 20/00

(57) ABSTRACT

Methods, systems, and apparatuses include receiving a plurality of event signals from verticals for an ongoing session of a user of an online system. Processed events are created by filtering content of the event signals using a unified schema. A unified action stream is created by aggregating the processed events. Features are generated using the unified action stream. An action sequence is generated using the unified action stream. Input data is generated for a trained machine learning model, the input data including the features and the action sequence. An output of the trained machine learning model is generated by applying the trained machine learning model to the input data.

### TECHNICAL FIELD

The present disclosure generally relates to machine learning, and more specifically, relates to sequence generation approaches to machine learning.

### BACKGROUND ART

Machine learning is a category of artificial intelligence. In machine learning, a model is defined by a machine learning algorithm. A machine learning algorithm is a mathematical and/or logical expression of a relationship between inputs to and outputs of the machine learning model. The model is trained by applying the machine learning algorithm to input data. A trained model can be applied to new instances of input data to generate model output. Machine learning model output can include a prediction, a score, or an inference, in response to a new instance of input data. Application systems can use the output of trained machine learning models to determine downstream execution decisions, such as decisions regarding various user interface functionality.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a unified action stream determination component and a sequence generation component in accordance with some embodiments of the present disclosure.

FIG. 2 illustrates another example computing system that includes a unified action stream determination component and a sequence generation component in accordance with some embodiments of the present disclosure.

FIG. 3 illustrates another example computing system that includes unified action stream determination component and a sequence generation component in accordance with some embodiments of the present disclosure.

FIG. 4 illustrates another example computing system that includes unified action stream determination component and a sequence generation component in accordance with some embodiments of the present disclosure.

FIG. 5 is a flow diagram of an example method to generate an action sequence for real time events in accordance with some embodiments of the present disclosure.

FIG. 6 is a block diagram of an example computer system in which embodiments of the present disclosure can operate.

### DETAILED DESCRIPTION

Conventional recommendation systems can use a variety of machine learning models to determine recommendations based on input features. These input features can vary for each of these machine learning models. For example, online social graph networks can include multiple verticals operating in parallel (e.g., different applications within the online social graph network) to receive information from users and provide recommendations. An online social graph network can include, for example, a search engine (e.g., a first vertical) that can be used to provide recommendations based on actual user input and a list of recommended content items (e.g., a second vertical) based on user data, such as data from a user profile. These verticals use different machine learning models which provide recommendations to the respective verticals based on different input features. Some of these recommendations may be generated from user data that is days, weeks, or months old. To provide high quality and accurate recommendations, these online social graph networks need to be able to predict user intent to a high degree of accuracy. Quality as used herein may refer to an objective metric that is measured by, for example, quantity of digital user engagement (e.g., views, reactions, comments, shares, etc.) with a specific recommendation or with a set of recommendations over time.

Due to the scope of online social graph networks, however, users may have different intents and desired outcomes when interacting with these online social graph networks. Each of the verticals for these online social graph networks relies on its own data and important features to predict the user intent. This results in a disparate set of user intents that, when put together, do not accurately reflect the actual intents of the user with respect to any one vertical. These conventional recommendation systems therefore fail to provide accurate and relevant recommendations for these users when the recommendations are generated from machine learning models using stale data and/or when the recommendation systems rely solely on vertical-specific data and features.

The shortcomings of these recommendation systems are particularly acute when implemented in large online systems subject to frequent change. Large online systems include systems that track historic data for large numbers of users interacting with the online system (e.g., millions or hundreds of millions of users). Large online systems also include systems with large amounts of network nodes and/or content items. For example, a large online system is a system with millions of content items and/or millions or network nodes. The exact number of users, content items, and/or nodes is not what defines a large online system, but rather the amount of data to be processed by the online systems relating to these users, content items, and/or nodes.

Users of large online social graph networks may initiate a session with a specific intent. For example, a user of an online job search network logs into the network and begins a session to search for a specific job. If this is the first time that the user had this intent, conventional recommendation systems are not able to provide accurate and relevant recommendations. For example, these conventional systems may use outdated user data reflecting an intent for a different job. Without the ability to use real-time or near-real-time events from the user, these conventional recommendation systems cannot provide accurate and relevant recommendations.

The terms real-time or near-real-time refer to a short period of time relevant to a user of a recommendation system. For example, real-time or near-real-time events can refer to events that happened in the same session (e.g., during a single period of time a user is interacting with the recommendation system, during an uninterrupted period of time that a user is interacting with a vertical). In some embodiments, real-time or near-real-time refer events are events that have occurred in the past 30 seconds. The terms real-time and near-real-time should not be interpreted as limited to a specific period of time but rather to a relevant period of time for a user of the recommendation system. For example, a user of a recommendation system that received a recommendation based on a search conducted by the user a minute ago can be interpreted as providing the recommendation in near real-time.

A recommendation system using a unified action stream based on real-time events as described herein includes a number of different components that alone or in combination address the above and other shortcomings of the conventional recommendation systems, particularly when applied to large online systems (e.g., social graph networks). For example, by generating a unified action stream based on real-time events from multiple verticals, the recommendation system can ensure that all verticals are using the same data and are updated in real-time or near-real-time, resulting in the recommendation system adapting in real-time or near-real-time to the user's changing intents.

Additionally, the recommendation system can consolidate different topics from multiple verticals to create a single action representation for the actual actions undertaken by the user while interacting with the network, rather than a subset of their actions based on a single vertical. This enhanced action stream can then be used to generate both input features for traditional machine learning models as well as action sequences for long short-term memory (LSTM) models, transformer models, and other sequence-based machine learning approaches. Because these inputs (e.g., input features and action sequences) are generated using the same real-time or near-real-time unified action scheme, the outputs of these models are more accurate and can be more easily combined and/or aggregated, resulting in more efficiency processing, higher accuracy, and more relevant recommendations.

Additionally, by using a unified action stream, these recommendation systems can reduce the amount of data they need to store. For example, each event in the unified action stream is represented using a unified schema that includes the most relevant information for the event as well as metadata identifying the event. This unified schema reduces the need to process extraneous and unnecessary data associated with the event that is not used for feature or sequence generation. This results in improved processing time which allows the recommendation system to generate and update the unified action stream in real-time or near-real-time.

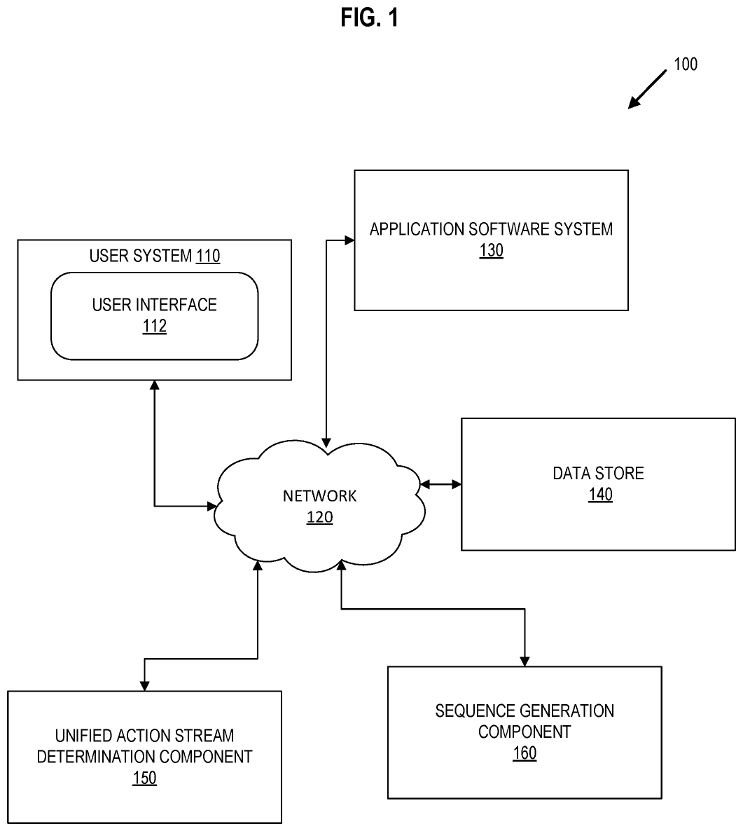

FIG. 1 illustrates an example of a computing system that includes a unified action stream determination component in accordance with some embodiments of the present disclosure.

In the embodiment of FIG. 1, computing system 100 includes a user system 110, a network 120, an application software system 130, a data store 140, a unified action stream determination component 150, and a sequence generation component 160. Each of these components of user trajectory processing system 100 are described in more detail below.

User system 110 includes at least one computing device, such as a personal computing device, a server, a mobile computing device, or a smart appliance. User system 110 includes at least one software application, including a user interface 112, installed on or accessible by a network to a computing device. For example, user interface 112 can be or include a front-end portion of application software system 130.

User interface 112 is any type of user interface as described above. User interface 112 can be used to input search queries and view or otherwise perceive output that includes data produced by application software system 130. For example, user interface 112 can include a graphical user interface and/or a conversational voice/speech interface that includes a mechanism for entering a search query and viewing query results and/or other digital content. Examples of user interface 112 include web browsers, command line interfaces, and mobile apps. User interface 112 as used herein can include application programming interfaces (APIs).

Network 120 can be implemented on any medium or mechanism that provides for the exchange of data, signals, and/or instructions between the various components of user trajectory processing system 100. Examples of network 120 include, without limitation, a Local Area Network (LAN), a Wide Area Network (WAN), an Ethernet network or the Internet, or at least one terrestrial, satellite or wireless link, or a combination of any number of different networks and/or communication links.

Application software system 130 is any type of application software system that includes or utilizes functionality and/or outputs provided by unified action stream determination component 150 and/or sequence generation component 160. Examples of application software system 130 include but are not limited to online services including connections network software, such as social media platforms, and systems that are or are not be based on connections network software, such as general-purpose search engines, content distribution systems including media feeds, bulletin boards, and messaging systems, special purpose software such as but not limited to job search software, recruiter search software, sales assistance software, advertising software, learning and education software, enterprise systems, customer relationship management (CRM) systems, or any combination of any of the foregoing.

A client portion of application software system 130 can operate in user system 110, for example as a plugin or widget in a graphical user interface of a software application or as a web browser executing user interface 112. In an embodiment, a web browser can transmit an HTTP request over a network (e.g., the Internet) in response to user input that is received through a user interface provided by the web application and displayed through the web browser. A server running application software system 130 and/or a server portion of application software system 130 can receive the input, perform at least one operation using the input, and return output using an HTTP response that the web browser receives and processes.

While not specifically shown, it should be understood that any of user system 110, application software system 130, data store 140, unified action stream determination component 150, and sequence generation component 160 includes an interface embodied as computer programming code stored in computer memory that when executed causes a computing device to enable bidirectional communication with any other of user system 110, application software system 130, data store 140, unified action stream determination component 150, and sequence generation component 160 using a communicative coupling mechanism. Examples of communicative coupling mechanisms include network interfaces, inter-process communication (IPC) interfaces and application program interfaces (APIs).

Data store 140 can include any combination of different types of memory devices. Data store 140 stores digital data used by user system 110, application software system 130, unified action stream determination component 150, and/or sequence generation component 160. Data store 140 can reside on at least one persistent and/or volatile storage device that can reside within the same local network as at least one other device of user trajectory processing system 100 and/or in a network that is remote relative to at least one other device of user trajectory processing system 100. Thus, although depicted as being included in user trajectory processing system 100, portions of data store 140 can be part of user trajectory processing system 100 or accessed by user trajectory processing system 100 over a network, such as network 120.

Each of user system 110, application software system 130, data store 140, unified action stream determination component 150, and sequence generation component 160 is implemented using at least one computing device that is communicatively coupled to electronic communications network 120. Any of user system 110, application software system 130, data store 140, unified action stream determination component 150, and sequence generation component 160 can be bidirectionally communicatively coupled by network 120. User system 110 as well as one or more different user systems (not shown) can be bidirectionally communicatively coupled to application software system 130.

A typical user of user system 110 can be an administrator or end user of application software system 130, unified action stream determination component 150, and/or sequence generation component 160. User system 110 is configured to communicate bidirectionally with any of application software system 130, data store 140, unified action stream determination component 150, and/or sequence generation component 160 over network 120.

The features and functionality of user system 110, application software system 130, data store 140, unified action stream determination component 150, and sequence generation component 160 are implemented using computer software, hardware, or software and hardware, and can include combinations of automated functionality, data structures, and digital data, which are represented schematically in the figures. User system 110, application software system 130, data store 140, unified action stream determination component 150, and sequence generation component 160 are shown as separate elements in FIG. 1 for ease of discussion but the illustration is not meant to imply that separation of these elements is required. The illustrated systems, services, and data stores (or their functionality) can be divided over any number of physical systems, including a single physical computer system, and can communicate with each other in any appropriate manner.

The unified action stream determination component 150 collects data from real-time events from verticals of an application software system (e.g., application software system 130 of FIG. 1) and processes and aggregates the data into a unified action stream accessible by feature generation components of machine learning models. This unified action stream is updated in real-time as new data comes in, allowing the machine learning models to always have access to the most up-to-date data. Further details with regard to the operations of unified action stream determination component 150 are described below.

The sequence generation component 160 generates action sequences from the unified action stream for use by long short-term memory (LSTM), transformer, and similar machine learning models. As mentioned above, because the unified action stream is updated in real-time as new data comes in, the action sequences generated from the action stream use the most up-to-date data. Further details with regard to the operations of sequence generation component 160 are described below.

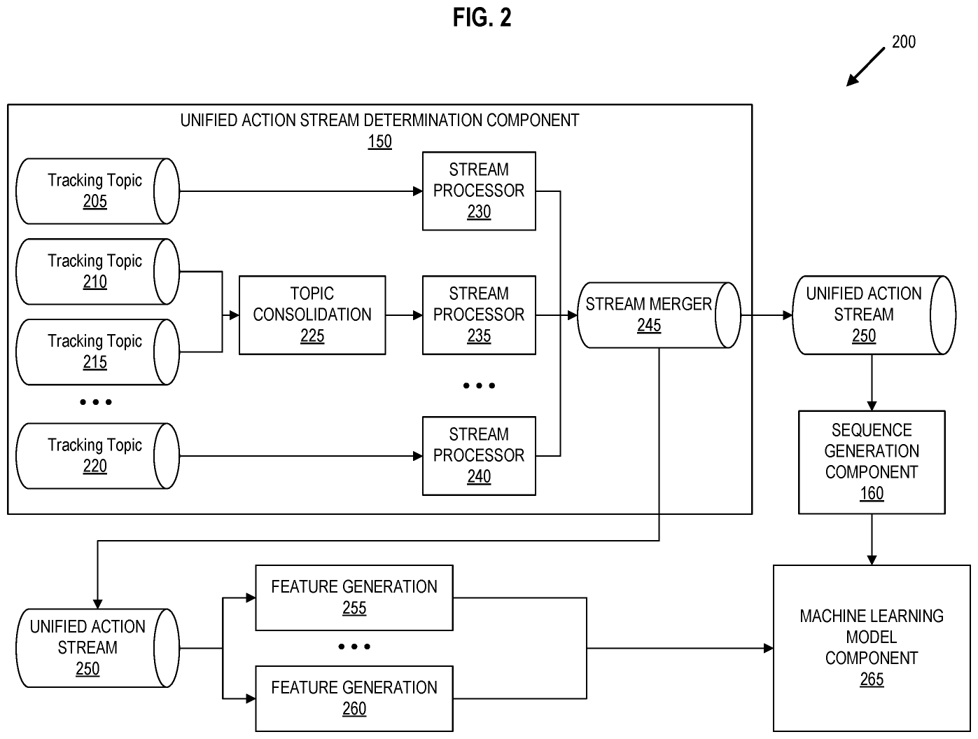

FIG. 2 illustrates an example of another computing system that includes a unified action stream determination component and a sequence generation component in accordance with some embodiments of the present disclosure.

As shown in FIG. 2, computing system 200 includes unified action stream determination component 150, sequence generation component 160, machine learning model component 265, unified action stream 250, and feature generation 255 and 260. Unified action stream determination component 150 includes tracking topics 205, 210, 215, and 220, topic consolidation 225, stream processors 230, 235, and 240, and stream merger 245.

Each of tracking topics 205, 210, 215, and 220 collect and aggregate data in near real-time from verticals of an application software system (e.g., application software system 130). For example, each of tracking topics 205, 210, 215, and 220 is a different application for an online social graph network. For example, tracking topic 205 is a vertical for a newsfeed, tracking topic 210 is a search engine vertical, tracking topic 215 is a search result vertical, and tracking topic 220 is a job search vertical. Tracking topics 205, 210, 215, and 220 receive data from a user interacting with the respective vertical of the application software system and send the data as real-time events (e.g., event signals) to their respective stream processors 230, 235, and 240.

In one embodiment, tracking topic 205 tracks data (e.g., event signals) relating to a user interacting with a newsfeed displayed on a user interface (e.g., user interface 112 of user system 110 of FIG. 1). For example, in response to a user interacting with a content item displayed on the user interface, tracking topic 205 sends a real-time event to stream processor 230. The real-time event includes details about the user and the content item. For example, the real-time event can include information about the user that interacted with the content item (such as a user ID), the type of interaction, the object of the interaction, a timestamp for when the interaction occurred (or when tracking topic 205 detected the interaction), the owner of the object received the action (e.g., a second user associated with a post that was liked), and metadata for the real-time event.

In some embodiments, unified action stream determination component 150 consolidates tracking topics before sending them to a stream processor. For example, as shown in FIG. 2, tracking topics 210 and 215 are sent to topic consolidation 225. Topic consolidation 225 consolidates the real-time events into a single consolidated real-time event which is sent to stream processor 235. In such embodiments, unified action stream determination component 150 consolidates tracking topics 210 and 215 because each of tracking topics 210 and 215 do not include sufficient information for creating a processed event under the unified schema. For example, the unified schema includes the following categories: a user that performed an action, the type of action performed, the object that received the action, a timestamp for the action, an owner of the object receiving the action, and metadata for the action. Tracking topic 210 tracks a user's input to a search engine vertical. The associated event therefore includes information about the query such as the user input used to initiate the query but does not include information about the action of the user in response to the query results (e.g., whether the user selects a result and/or which result the user selects). In such embodiments, unified action stream determination component 150 uses the real-time event data from tracking topic 210 and consolidates it with real-time event data from tracking topic 215, tracking the results of the query. Accordingly, the data sent to stream processor 235 includes both the details about the query (e.g., what the user input to initiate the query) as well as the resulting actions of the query (e.g., the user selected a specific content item). In some embodiments, unified action stream determination component 150 consolidates tracking topics in response to determining that that tracking topics 210 and 215 alone do not include all of the required categories for the unified schema.

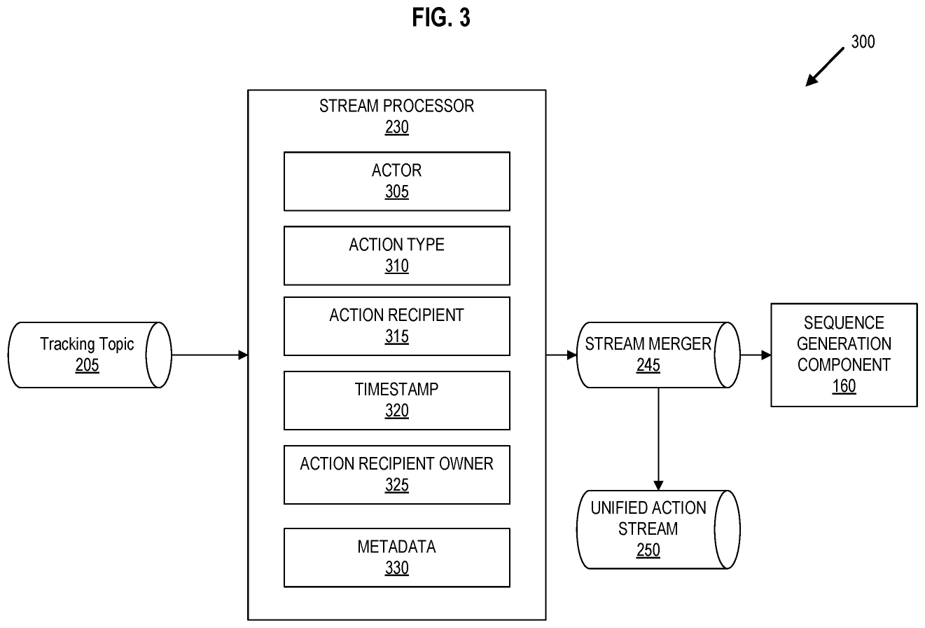

Stream processors 230, 235, and 240 receive the real-time events and create processed events based on a unified schema. For example, as mentioned above, the unified schema includes the following categories: a user that performed an action, the type of action performed, the object that received the action, a timestamp for the action, an owner of the object receiving the action, and metadata for the action. Stream processors 230, 235, and 240 receive the real-time events from tracking topics 205 and 220 and from topic consolidation 225 and generate a processed event with categories generated from the real-time event data. For example, in response to tracking topic 205 sending a real-time event for a user liking a post on their news feed, stream processor 230 creates a processed event including the user performed the action (e.g., the user that liked the post), the type of action (e.g., a like), the object that received the action (e.g., the post that was liked), the timestamp of the action (e.g., a time at which the user liked the post), the owner of the object receiving the action (e.g., the entity that created the post), and metadata associated with the action (e.g., the content of the post). Further details regarding the unified schema are explained with reference to FIG. 3.

In some embodiments, stream processors 230, 235, and 240 filter out data from the real-time event that does not fall into one of the categories of the unified action stream. For example, tracking topic 220 sends a real-time event to stream processor 240 in response to a user saving a job post. In such an example, the object of the interaction is the job post and the owner of the object that received the action is the job itself. In such an embodiment, tracking topic 220 also sends the entity ID for the entity that posted the job post to stream processor 240. In such embodiments, stream processor 240 generates a processed event without the entity ID for the entity that posted the job post. Accordingly, because stream processors 230, 235, and 240 use a unified schema with specific categories, not all of the real-time event data from tracking topics 205, 210, 215, and 220 is included in the processed events. This reduces the amount of data that has to be processed by unified action stream determination component 150, improving the efficiency and allowing unified action stream determination component 150 to process the events and generate unified action stream 250 in real-time or near-real-time.

Unified action stream determination component 150 sends the processed events from stream processors 230, 235, and 240 to stream merger 245. Stream merger receives the processed events from stream processors 230, 235, and 240 and generates unified action stream 250. For example, unified action stream 250 is a stream of processed events detected by tracking topics 205, 210, 215, and 220. In some embodiments, stream merger 245 generates unified action stream 250 using timestamps from each of the processed events. For example, stream merger 245 generates unified action stream 250 as a series of processed events in chronological order according to the timestamps. In some embodiments, stream merger 245 stores unified action stream 250 in a database. For example, stream merger 245 stores unified action stream 250 in a data store (e.g., data store 140) accessible by downstream machine learning components such as feature generation 255 and 260 and machine learning model component 265.

Feature generation 255 and 260 are components of an application software system (e.g., application software system 130) that generate features for machine learning models. For example, feature generation 255 generates input features for candidate retrieval models and feature generation 260 generates input features for candidate ranking models for a recommendation system. Feature generation 255 and 260 generate the input features for the applicable machine learning model based on unified action stream 250. For example, a candidate ranking machine learning model for providing job recommendations uses input features relating to jobs saved by a user, entities a user interacted with, and others. Feature generation 255 takes unified action stream 250 and retrieves features using data processed events from unified action stream 250.

In some embodiments, feature generation 255 and 260 retrieve data associated with a processed event of unified action stream 250 using a category of unified action stream 250. For example, feature generation 255 takes an event from unified action stream 250 of a user saving a job post. Feature generation 255 uses the job post identifier (e.g., object that received action in unified schema) of unified action stream 250 to retrieve additional features relating to the job post (e.g., skills associated with job post, seniority level, industry, etc.). In another example, feature generation 255 takes an event from unified action stream 250 for a user liking a post. Feature generation 255 uses the entity identifier (e.g., owner of object receiving the action) to retrieve additional features relating to the entity (e.g., other job postings, industry, etc.). In some embodiments, feature generation 255 and 260 retrieve the data from a data store (e.g., data store 140 of FIG. 1). For example, data store 140 includes tables and metadata linking identifiers (e.g., user identifiers, entity identifiers, etc.) with additional data about the entities associated with the identifiers. Feature generation 255 and 260 use categories of the unified action stream 250 to retrieve this additional data from data store 140 for use in feature generation. In some embodiments, feature generation 255 and 260 store the generated features in a data store for future use. For example, feature generation 255 and 260 store the generated features in data store 140 of FIG. 1.

In some embodiments, unified action stream determination component 150 sends unified action stream 250 to sequence generation component 160. Sequence generation component 160 receives unified action stream 250 and generates action sequences using unified action stream 250. In some embodiments, sequence generation component 160 retrieves unified action stream 250 from a data store (e.g., data store 140 of FIG. 1). In some embodiments, sequence generation component 160 generates action sequences for use as features in machine learning model component 265. For example, sequence generation component 160 generates action sequences for use by an LSTM and/or transformer model of machine learning model component 265.

In some embodiments, sequence generation component 160 extracts the action sequences from unified action stream 250 using sliding time windows. For example, sequence generation component 160 generates action sequences for a sliding time window of 30 minutes. In such embodiments, each of the generated action sequences includes actions of unified action stream 250 with timestamps in the relevant 30-minute period of time.

In some embodiments, sequence generation component 160 generates the action sequences using a trigger. For example, sequence generation component 160 generates a new action sequence in response to detecting a new real-time event (e.g., unified action stream 250 has been updated with a new action from one of tracking topics 205, 210, 215, and/or 220). In some embodiments, sequence generation component 160 generates a new action sequence in response to determining that a previous action sequence has expired. For example, sequence generation component 160 determines that an age for a previous action sequence is greater than a threshold age and generates a new action sequence.

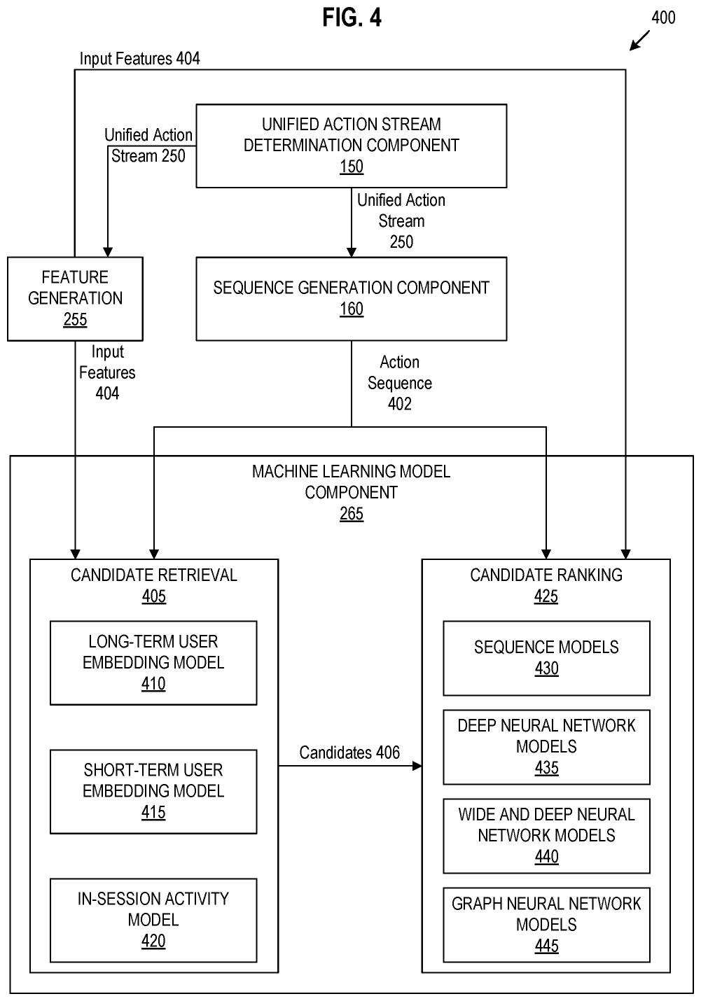

In some embodiments, sequence generation component 160 sends the generated action sequences to machine learning model component 265. For example, sequence generation component 160 sends the generated action sequences as inputs to sequence machine learning models of machine learning model component 265. In some embodiments, machine learning model component 265 generates embeddings for users based on the received action sequences. For example, machine learning model component 265 includes a user embedding model that generates an embedding for a user based on the action sequence generated from 24 interactions between the user and application software system 130. Further details regarding user embeddings and machine learning model component 265 are described with reference to FIG. 4.

In some embodiments, machine learning model component 265 uses the user embedding as an input feature for other machine learning models in machine learning model component 265, such as for candidate retrieval and ranking models. Because the user embeddings are generated using real-time or near-real-time data from unified action stream 250 (e.g., from the action sequences), the user embeddings stay up to date and the candidates retrieval and ranking models provide more accurate and relevant recommendations for the user. Additionally, since the other input features of the candidate retrieval and ranking models (e.g., other than the action sequences) are generated using the same up-to-date unified action stream 250, all of the inputs for these machine learning models stay in sync and relevant for the user's ongoing session. Therefore, as a user interacts with a particular entity or type of entity more and more during the same session, the likelihood of that entity being recommended to the user increases.

In some embodiments, unified action stream determination component 150 updates unified action stream 250. For example, in response to any of tracking topics 205, 210, 215, and/or 220 detecting a new real-time event and sending the data for the new real-time event to stream processors 230 and 240 and/or topic consolidation 225, unified action stream determination component 150 updates unified action stream 250 with the processed data from the new real-time event. In such a way, unified action stream 250 stays up-to-date based on any information received by unified action stream determination component 150 for any of the verticals of application software system 130.

FIG. 3 illustrates another example computing system 300 that includes unified action stream determination component and a sequence generation component in accordance with some embodiments of the present disclosure.

As shown in FIG. 3, stream processor 230 receives real-time event data from tracking topic 205 and creates a processed event using the unified schema. In one embodiment, the unified schema includes actor 305, action type 310, action recipient 315, timestamp 320, action recipient owner 325, and metadata 330. Actor 305 is the actor performing an action associated with a real-time event tracked by tracking topic 205. For example, actor 305 is a user identifier for the user interacting with a vertical of user interface 112. Action type 310 is the action that actor 305 performs. For example, action type 310 refers to the method of interaction with the vertical of user interface 112 (e.g., liked a comment, saved a job listing, messaged another user). Action recipient 315 is the recipient of the action by actor 305. For example, action recipient 315 refers to the object of the interaction (e.g., comment that was liked, job listing that was saved, message that was sent). Timestamp 320 is a timestamp for when the action occurred. For example, timestamp 320 is a timestamp for when application software system 130 detected the interaction between the user and user interface 112. Action recipient owner 325 is the owner of action recipient 315. For example, if the action recipient action recipient 315 is a comment, action recipient owner 325 is the poster of the comment, if action recipient 315 is a job listing, timestamp action recipient owner 325 is the job associated with the listing, and if action recipient 315 is a message, action recipient owner 325 is the recipient of the message. Metadata 330 is additional data associated with the action. For example, for a query, the metadata includes the user input (e.g., query text) for the query.

FIG. 4 illustrates another example computing system that includes unified action stream determination component and a sequence generation component in accordance with some embodiments of the present disclosure.

In one embodiment, example computing system 400 includes unified action stream determination component 150, sequence generation component 160, feature generation 255 and machine learning model component 265. Although only one feature generation (e.g., feature generation 255) is illustrated for the purpose of simplicity, example computing system can include multiple feature generation 255. As shown in FIG. 4, machine learning model component 265 includes candidate retrieval 405 and candidate ranking 425. Each of candidate retrieval 405 and ranking 425 include machine learning models for retrieving and ranking candidates respectively for a recommendation system.

In one embodiment, candidate retrieval 405 includes long-term user embedding model 410, short-term user embedding model 415, and in-session activity model 420. Although only three models are illustrated, candidate retrieval 405 can include multiple models for generating embeddings and retrieving candidates. For example, candidate retrieval 405 can include models for determining trending candidates (e.g., content items that are trending) and for determining user categories (e.g., classifying users). Although illustrated as separate models, long-term user embedding model 410, short-term user embedding model 415, and in-session activity model 420 can be combined with each other or with other models of machine learning model component 265 into larger groups of machine learning models that act in cooperation. Since all of these models rely on input features and action sequences derived from the same unified action stream 250, these models are in sync and better able to provide more relevant recommendations with less training data.

In one embodiment, candidate ranking 425 includes sequence models 430, deep neural network models 435, wide and deep neural network models 440, and graph neural network models 445. Although only four models are illustrated, candidate ranking 425 can include multiple models for ranking candidates. For example, candidate ranking 425 can include linear regression models and extreme gradient boosting models. Although illustrated as separate models, sequence models 430, deep neural network models 435, wide and deep neural network models 440, and graph neural network models 445 can be combined with each other or with other models of machine learning model component 265 into larger groups of machine learning models that act in cooperation. Since all of these models rely on input features and action sequences derived from the same unified action stream 250, these models are in sync and better able to provide more relevant recommendations with less training data.

As shown in FIG. 4, unified action stream determination component 150 sends unified action stream 250 to sequence generation component 160 and feature generation 255. Sequence generation component 160 receives unified action stream 250 and generates action sequence 402 as described with reference to FIGS. 2 and 3. Feature generation 255 receives unified action stream 250 and generates input features 404 as described with reference to FIGS. 2 and 3. Sequence generation component 160 and feature generation 255 send action sequence 402 and input features 404 respectively to both candidate retrieval 405 and candidate ranking 425. In some embodiments, the input features 404 sent to candidate retrieval 405 and candidate ranking 425 differ. For example, as explained with reference to FIG. 3, different models require different input features. Accordingly, feature generation 255 can generate different sets of input features for each of candidate retrieval 405 and candidate ranking 425.

In some embodiments, feature generation 255 generates different features for models within each of candidate retrieval 405 and candidate ranking 425. For example, feature generation 255 generates different sets of input features for each of long-term user embedding model 410, short-term user embedding model 415, in-session activity model 420, sequence models 430, deep neural network models 435, wide and deep neural network models 440, and graph neural network models 445. In some embodiments, some models from candidate retrieval 405 and candidate ranking 425 do not use input features 404. For example, sequence models 430 may only use action sequence 402. Long-term user embedding model 410 is a machine learning model for generating user embeddings using user data for longer periods of time than short-term user embedding model 415. For example, long-term user embedding model 410 generates user embeddings using all user data stored. Short-term user embedding model 415 is a machine learning model for generating user embeddings using user data for an ongoing user session. For example, short-term user embedding model 415 generates user embedding with data for a current ongoing session of a user.

As shown in FIG. 4, candidate retrieval 405 uses action sequence 402 and input features 404 to generate a list of candidates 406. Candidate retrieval 405 sends candidates 406 to candidate ranking 425 for ranking. In some embodiments, candidate retrieval 405 sends other information to candidate ranking 425. For example, candidate retrieval 405 sends user embedding to candidate ranking 425 for use in graph neural network models 445. Candidate ranking 425 receives candidates 406 and ranks candidates 406 using action sequence 402 and input features 404. For example, models of candidate ranking 425 use action sequence 402 and input features 404 to ranking the candidates 406 based on what would be relevant to a user.

In some embodiments, candidate ranking 425 ranks candidates 406 using up-to-date short-term user embeddings for the user's ongoing session (e.g., generated by short-term user embedding model 415) generated from the real-time information from unified action stream determination component 150. Accordingly, in such embodiments, candidate ranking 425 is able to better rank candidates based on a user's displayed preferences for the ongoing session.

In some embodiments, candidate ranking 425 ranks candidates 406 using up-to-date long-term user embeddings for the user's ongoing session (e.g., generated by long-term user embedding model 410) generated from the real-time information from unified action stream determination component 150. Because these embeddings are generated for longer periods of time, the user's ongoing session has less influence on the generated embedding. By using both short-term user embeddings and long-term user embeddings, candidate ranking 425 is able to rank both based on user's historically displayed preferences as well as preferences for the ongoing session. Additionally, because these models can be used together, candidate ranking 425 can determine weights for ranking using both short-term user embeddings and long-term user embeddings and can therefore generate recommendations for the user using different combinations of these embeddings.

Machine learning model component 265 generates recommendations for the user based on candidate ranking 425 ranking candidates 406. For example, machine learning model component 265 selects the top five ranked candidates and provides these candidates as recommendations for the user. In some embodiments, machine learning model component 265 sends the recommendations to the user device to be presented to the user. For example, machine learning model component 265 sends the recommendations through application software system 130 to user system 110 causing the recommendations to be displayed on user interface 112.

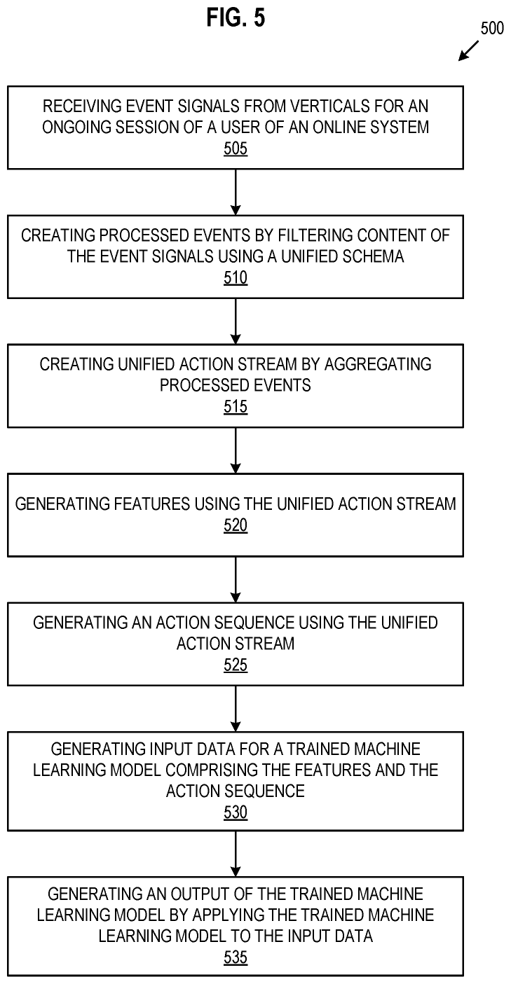

FIG. 5 is a flow diagram of an example method 500 to generate an action sequence for real time events, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by unified action stream determination component 150 of FIG. 1. In other embodiments, the method 500 is performed by sequence generation component 160 of FIG. 1. In still other embodiments, parts of the method 500 are performed by method 500 unified action stream determination component 150 of FIG. 1 and parts of the method 500 are performed by sequence generation component 160 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 505, the processing device receives event signals from verticals for an ongoing session of a user of an online system. For example, unified action stream determination component 150 receives event signals from application software system 130 in response to a user interacting with user interface 112 of the application software system 130. Further details regarding receiving event signals from verticals for an ongoing session of a user of an online system are described with reference to FIG. 2.

At operation 510, the processing device creates processed events by filtering content of the event signals using a unified schema. For example, stream processors 230 creates processed events including unified schema including an actor 305, an action type 310, an action recipient 315, a timestamp 320, an action recipient owner 325, and metadata 330. Further details regarding creating processed events by filtering content of the event signals using a unified schema are described with reference to FIGS. 2 and 3.

At operation 515, the processing device creates a unified action stream by aggregating processed events. For example, unified action stream determination component 150 aggregates processed events from stream processors 230, 235, and 240 into unified action stream 250. In some embodiments, the processing device stores the unified actions stream in a data store for future use. Further details regarding creating a unified action stream by aggregating processed events are described with reference to FIG. 2.

At operation 520, the processing device generates features using the unified action stream. For example, feature generation 255 and 260 generate features for use by machine learning model component 265 using unified action stream 250. In some embodiments, feature generation 255 and 260 use categories of unified action stream 250 to retrieve additional data for an event in unified action stream 250. For example, feature generation 255 uses a user identifier for an actor (e.g., actor 305 of FIG. 3) of an action in unified action stream 250 to retrieve features associated with the actor. Further details regarding generating features using the unified action stream are described with reference to FIG. 2.

At operation 525, the processing device generates an action sequence using the unified action stream. For example, sequence generation component 160 generates an action sequence for the user using unified action stream 250. In some embodiments, sequence generation component 160 generates an action sequence using a sliding time window. For example, sequence generation component 160 generates an action sequence where actions in the action sequence all have timestamps (e.g., timestamp 320 of FIG. 3) within the same 30 minute time window. In some embodiments, sequence generation component 160 generates an action sequence in response to a trigger. For example, sequence generation component 160 generates an action sequence in response to determining that a new action has been included in unified action stream 250 and/or in response to determining that a previous action sequence has expired. Further details regarding generating an action sequence using the unified action stream are described with reference to FIG. 2.

At operation 530, the processing device generates input data for a trained machine learning model including the features and the action sequence. For example, machine learning model component 265 uses the generated features and the action sequence to generate input data for a recommendation model. In some embodiments, the processing device determines a user embedding using the action sequence and generates input data for a recommendation model using the generated features and the user embedding. Further details regarding generating input data for a trained machine learning model including the features and the action sequence are described with reference to FIG. 2.

At operation 535, the processing device generates an output of the trained machine learning model by applying the machine learning model to the input data. For example, machine learning model component 265 generates an output of a recommendation model. In some embodiments, the processing device provides causes the recommendation to be displayed to the user in the ongoing session. For example, machine learning model component 265 causes user interface 112 to display the output of machine learning model component 265 to the user. Further details regarding generating an output of the trained machine learning model by applying the machine learning model to the input data are described with reference to FIG. 2.

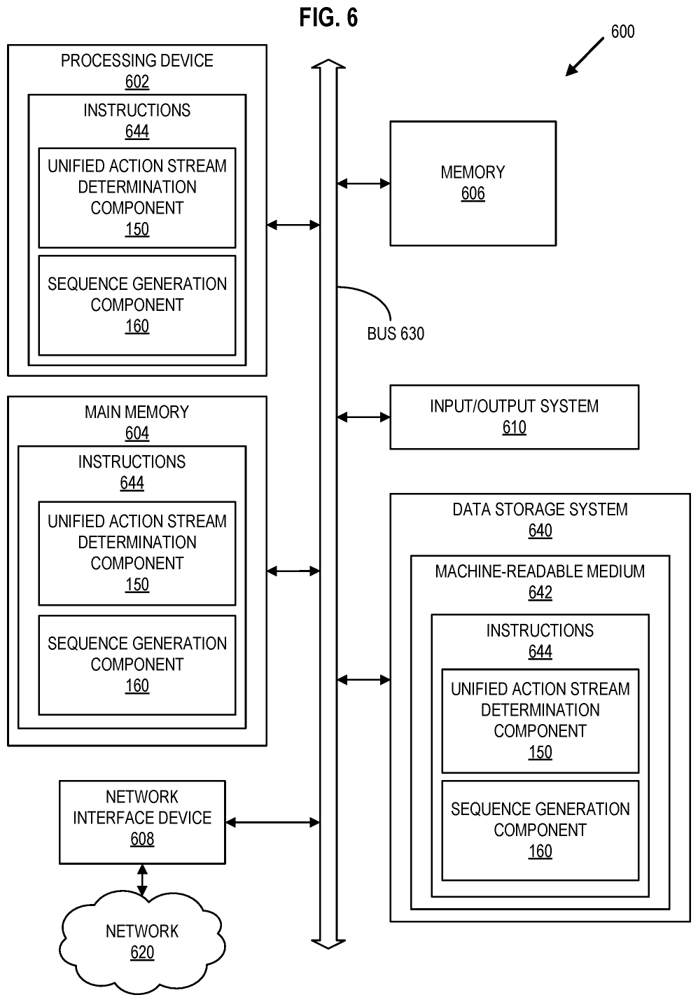

FIG. 6 illustrates an example machine of a computer system 600 within which a set of instructions, for causing the machine to perform any one or more of the methodologies discussed herein, can be executed. In some embodiments, the computer system 600 can correspond to a component of a networked computer system (e.g., the computing system 100 of FIG. 1) that includes, is coupled to, or utilizes a machine to execute an operating system to perform operations corresponding to unified action stream determination component 150 and/or sequence generation component 160 of FIG. 1. The machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a smart phone, a tablet PC, a set-top box (STB), a Personal Digital Assistant (PDA), a cellular telephone, a web appliance, a server, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random-access memory (DRAM) such as synchronous DRAM (SDRAM) or Rambus DRAM (RDRAM), etc.), a memory 606 (e.g., flash memory, static random-access memory (SRAM), etc.), an input/output system 610, and a data storage system 640, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 644 for performing the operations and steps discussed herein.

The computer system 600 can further include a network interface device 608 to communicate over network 620. Network interface device 608 can provide a two-way data communication coupling to a network. For example, network interface device 608 can be an integrated-services digital network (ISDN) card, cable modem, satellite modem, or a modem to provide a data communication connection to a corresponding type of telephone line. As another example, network interface device 608 can be a local area network (LAN) card to provide a data communication connection to a compatible LAN. Wireless links can also be implemented. In any such implementation network interface device 608 can send and receive electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 600.

Computer system 600 can send messages and receive data, including program code, through the network(s) and network interface device 608. In the Internet example, a server can transmit a requested code for an application program through the Internet and network interface device 608. The received code can be executed by processing device 602 as it is received, and/or stored in data storage system 640, or other non-volatile storage for later execution.

The input/output system 610 can include an output device, such as a display, for example a liquid crystal display (LCD) or a touchscreen display, for displaying information to a computer user, or a speaker, a haptic device, or another form of output device. The input/output system 610 can include an input device, for example, alphanumeric keys and other keys configured for communicating information and command selections to processing device 602. An input device can, alternatively or in addition, include a cursor control, such as a mouse, a trackball, or cursor direction keys for communicating direction information and command selections to processing device 602 and for controlling cursor movement on a display. An input device can, alternatively or in addition, include a microphone, a sensor, or an array of sensors, for communicating sensed information to processing device 602. Sensed information can include voice commands, audio signals, geographic location information, and/or digital imagery, for example.

The data storage system 640 can include a machine-readable storage medium 642 (also known as a computer-readable medium) on which is stored one or more sets of instructions 644 or software embodying any one or more of the methodologies or functions described herein. The instructions 644 can also reside, completely or at least partially, within the main memory 604 and/or within the processing device 602 during execution thereof by the computer system 600, the main memory 604 and the processing device 602 also constituting machine-readable storage media.

In one embodiment, instructions 644 include instructions to implement functionality corresponding to a unified action stream determination component (e.g., unified action stream determination component 150 of FIG. 1). In another embodiment, instructions 644 include instructions to implement functionality corresponding to a sequence generation component (e.g., sequence generation component 160 of FIG. 1). In yet another embodiment, the instructions 644 include instructions to implement functionality corresponding to a unified action stream determination component and a sequence generation component (e.g., unified action stream determination component 150 and sequence generation component 160 of FIG. 1). While the machine-readable storage medium 642 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

An example 1 includes a method comprising: receiving a plurality of event signals from a plurality of verticals for an ongoing session of a user of an online system; creating a plurality of processed events by filtering content of the plurality of event signals using a unified schema comprising a plurality of categories; creating a unified action stream by aggregating the plurality of processed events; generating a plurality of features using the unified action stream; generating an action sequence using the unified action stream; generating input data for a trained machine learning model, the input data comprising the plurality of features and the action sequence; and generating an output of the trained machine learning model by applying the trained machine learning model to the input data.

An example 2 includes the subject matter of example 1, wherein generating the plurality of features using the unified action stream comprises: retrieving data associated with a processed event of the unified action stream using a category of the plurality of categories; and generating the plurality of features using the retrieved data and the processed event.

An example 3 includes the subject matter of any of examples 1 and 2, wherein generating input data for the trained machine learning model further comprises: generating a user embedding for the user using the action sequence, wherein the input data comprises the plurality of features and the user embedding.

An example 4 includes the subject matter of example 3, wherein the trained machine learning model is a recommendation model and the output is a recommendation, the method further comprising: causing the recommendation to be presented to the user in the ongoing session.

An example 5 includes the subject matter of any of examples 1-4, wherein creating the plurality of processed events further comprises: consolidating two or more event signals of the plurality of event signals into a consolidated event; and filtering content of the consolidated event using the unified schema.

An example 6 includes the subject matter of example 5, wherein consolidating the two or more event signals is in response to determining that each of the two or more event signals do not satisfy a category threshold and that the two or more event signals together do satisfy the category threshold.

An example 7 includes the subject matter of any of examples 1-6, wherein generating the action sequence comprises: extracting an action sequence from the unified action stream using a sliding time window.

An example 8 includes the subject matter of any of examples 1-7, further comprising: detecting a trigger to generate the action sequence, wherein generating the action sequence is in response to detecting the trigger.

An example 9 includes the subject matter of example 8, wherein the trigger comprises: detecting a subsequent event for the ongoing session.

An example 10 includes the subject matter of any of examples 1-9, further comprising: generating a short-term user embedding for the ongoing session using the plurality of features and the action sequence, wherein the input data further comprises the short-term user embedding.

An example 11 includes a system comprising: at least one memory device; and a processing device, operatively coupled with the at least one memory device, to: receive a plurality of event signals from a plurality of verticals for an ongoing session of a user of an online system; create a plurality of processed events by filtering content of the plurality of event signals using a unified schema comprising a plurality of categories; create a unified action stream by aggregating the plurality of processed events; generate a plurality of features using the unified action stream; generate an action sequence using the unified action stream; generate input data for a trained machine learning model, the input data comprising the plurality of features and the action sequence; and generate an output of the trained machine learning model by applying the trained machine learning model to the input data.

An example 12 includes the subject matter of example 11, wherein generating the plurality of features using the unified action stream comprises: retrieving data associated with a processed event of the unified action stream using a category of the plurality of categories; and generating the plurality of features using the retrieved data and the processed event.

An example 13 includes the subject matter of any of examples 11 and 12, wherein generating input data for the trained machine learning model further comprises: generating a user embedding for the user using the action sequence, wherein the input data comprises the plurality of features and the user embedding.

An example 14 includes the subject matter of any of examples 11-13, wherein creating the plurality of processed events further comprises: consolidating two or more event signals of the plurality of event signals into a consolidated event; and filtering content of the consolidated event using the unified schema.

An example 15 includes the subject matter of example 14, wherein consolidating the two or more event signals is in response to determining that each of the two or more event signals do not satisfy a category threshold and that the two or more event signals together do satisfy the category threshold.

An example 16 includes the subject matter of any of examples 11-15, wherein generating the action sequence comprises: extracting an action sequence from the unified action stream using a sliding time window.

An example 17 includes the subject matter of any of examples 11-16, wherein the processing device is further to: detect a trigger to generate the action sequence, wherein generating the action sequence is in response to detecting the trigger.

An example 18 includes the subject matter of example 17, wherein the trigger comprises: detecting a subsequent event for the ongoing session.

An example 19 includes the subject matter of any of examples 17-18, wherein the processing device is further to: generate a short-term user embedding for the ongoing session using the plurality of features and the action sequence, wherein the input data further comprises the short-term user embedding.

An example 20 includes a system comprising: at least one memory device; and a processing device, operatively coupled with the at least one memory device, to: receive a plurality of event signals from a plurality of verticals for an ongoing session of a user of an online system; create a plurality of processed events by filtering content of the plurality of event signals using a unified schema comprising a plurality of categories; create a unified action stream by aggregating the plurality of processed events; generate a plurality of features using the unified action stream; generate an action sequence using the unified action stream; generate a user embedding for the user using the action sequence; generate input data for a trained recommendation model, the input data comprising the plurality of features and the user embedding; generate a recommendation from the trained recommendation model by applying the trained recommendation model to the input data; and cause the recommendation to be presented to the user in the ongoing session.

The techniques described herein may be implemented with privacy safeguards to protect user privacy. Furthermore, the techniques described herein may be implemented with user privacy safeguards to prevent unauthorized access to personal data and confidential data. The training of the artificial intelligence (AI) models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities.

The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the user trajectory processing system 100, can carry out the computer-implemented method 500 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc. Illustrative examples of the technologies disclosed herein are provided below. An embodiment of the technologies may include any of the examples or a combination of the described below. In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving a plurality of event signals from a plurality of verticals for an ongoing session of a user of an online system;
creating a plurality of processed events by filtering content of the plurality of event signals using a unified schema comprising a plurality of categories;
creating a unified action stream by aggregating the plurality of processed events;
generating a plurality of features using the unified action stream;
generating an action sequence using the unified action stream;
generating input data for a trained machine learning model, the input data comprising the plurality of features and the action sequence; and
generating an output of the trained machine learning model by applying the trained machine learning model to the input data.

2. The method of claim 1, wherein generating the plurality of features using the unified action stream comprises:
retrieving data associated with a processed event of the unified action stream using a category of the plurality of categories; and
generating the plurality of features using the retrieved data and the processed event.

3. The method of claim 1, wherein generating input data for the trained machine learning model further comprises:
generating a user embedding for the user using the action sequence, wherein the input data comprises the plurality of features and the user embedding.

4. The method of claim 3, wherein the trained machine learning model is a recommendation model and the output is a recommendation, the method further comprising:
causing the recommendation to be presented to the user in the ongoing session.

5. The method of claim 1, wherein creating the plurality of processed events further comprises:
consolidating two or more event signals of the plurality of event signals into a consolidated event; and
filtering content of the consolidated event using the unified schema.

6. The method of claim 5, wherein consolidating the two or more event signals is in response to determining that each of the two or more event signals do not satisfy a category threshold and that the two or more event signals together do satisfy the category threshold.

7. The method of claim 1, wherein generating the action sequence comprises:
extracting an action sequence from the unified action stream using a sliding time window.

8. The method of claim 1, further comprising:
detecting a trigger to generate the action sequence, wherein generating the action sequence is in response to detecting the trigger.

9. The method of claim 8, wherein the trigger comprises:
detecting a subsequent event for the ongoing session.

10. The method of claim 1, further comprising:
generating a short-term user embedding for the ongoing session using the plurality of features and the action sequence, wherein the input data further comprises the short-term user embedding.

11. A system comprising:
at least one memory device; and
a processing device, operatively coupled with the at least one memory device, to:
receive a plurality of event signals from a plurality of verticals for an ongoing session of a user of an online system;
create a plurality of processed events by filtering content of the plurality of event signals using a unified schema comprising a plurality of categories;
create a unified action stream by aggregating the plurality of processed events;
generate a plurality of features using the unified action stream;
generate an action sequence using the unified action stream;
generate input data for a trained machine learning model, the input data comprising the plurality of features and the action sequence; and
generate an output of the trained machine learning model by applying the trained machine learning model to the input data.

12. The system of claim 11, wherein generating the plurality of features using the unified action stream comprises:
retrieving data associated with a processed event of the unified action stream using a category of the plurality of categories; and
generating the plurality of features using the retrieved data and the processed event.

13. The system of claim 11, wherein generating input data for the trained machine learning model further comprises:
generating a user embedding for the user using the action sequence, wherein the input data comprises the plurality of features and the user embedding.

14. The system of claim 11, wherein creating the plurality of processed events further comprises:
consolidating two or more event signals of the plurality of event signals into a consolidated event; and
filtering content of the consolidated event using the unified schema.

15. The system of claim 14, wherein consolidating the two or more event signals is in response to determining that each of the two or more event signals do not satisfy a category threshold and that the two or more event signals together do satisfy the category threshold.

16. The system of claim 11, wherein generating the action sequence comprises:
extracting an action sequence from the unified action stream using a sliding time window.

17. The system of claim 11, wherein the processing device is further to:
detect a trigger to generate the action sequence, wherein generating the action sequence is in response to detecting the trigger.

18. The system of claim 17, wherein the trigger comprises:
detecting a subsequent event for the ongoing session.

19. The system of claim 17, wherein the processing device is further to:
generate a short-term user embedding for the ongoing session using the plurality of features and the action sequence, wherein the input data further comprises the short-term user embedding.

20. A system comprising:
at least one memory device; and
a processing device, operatively coupled with the at least one memory device, to:
receive a plurality of event signals from a plurality of verticals for an ongoing session of a user of an online system;
create a plurality of processed events by filtering content of the plurality of event signals using a unified schema comprising a plurality of categories;
create a unified action stream by aggregating the plurality of processed events;
generate a plurality of features using the unified action stream;
generate an action sequence using the unified action stream;
generate a user embedding for the user using the action sequence;
generate input data for a trained recommendation model, the input data comprising the plurality of features and the user embedding;
generate a recommendation from the trained recommendation model by applying the trained recommendation model to the input data; and
cause the recommendation to be presented to the user in the ongoing session.
